(19) United States
(12) Patent Application Publication
(10) Pub. No.: US 2024/0418654 A1
(43) Pub. Date: Dec. 19, 2024

(54) LIBS ANALYSIS DEVICE WITH AUTO-FOCUSING AND MICRO-AREA IMAGING FUNCTIONS AND APPLICATION OF LIBS ANALYSIS DEVICE

(71) Applicant: Hefei Institutes of Physical Science, CAS, Hefei City (CN)

(72) Inventors: Zhirong ZHANG, Hefei City (CN); Mengyang ZHANG, Hefei City (CN); Hongbo FU, Hefei City (CN); Huadong WANG, Hefei City (CN); Bian WU, Hefei City (CN)

(73) Assignee: Hefei Institutes of Physical Science, CAS, Hefei City (CN)

(21) Appl. No.: 18/334,459

(22) Filed: Jun. 14, 2023

(51) Int. Cl. G01N 21/71; G02B 7/02; G02B 7/08

(52) U.S. Cl. CPC G01N 21/718; G02B 7/021; G02B 7/08; G01N 2201/0221; G01N 2201/06113; G02B 27/144

(57) ABSTRACT

Disclosed are a LIBS (Laser-Induced Breakdown Spectroscopy) analysis device with auto-focusing and micro-area imaging functions and application of the LIBS analysis device. A device body of the LIBS analysis device includes a mounting seat. A pulse laser, an optical path module and an auto-focusing module are arranged on the mounting seat. The optical path module includes a first mounting box, a second mounting box and a third mounting box. The first mounting box, the second mounting box and the third mounting box are internally provided with a perforated total reflector, a beam splitter and a total reflector, respectively. The auto-focusing module and the pulse laser are respectively arranged on both sides of the first mounting box. An optical fiber coupler is connected to a side face of the second mounting box. A camera is connected to a side face of the third mounting box.

### TECHNICAL FIELD

The present disclosure relates to the technical field of laser-induced breakdown spectroscopy, and in particular to a LIBS (Laser-Induced Breakdown Spectroscopy) analysis device with auto-focusing and micro-area imaging functions and application of the LIBS analysis device.

### BACKGROUND

LIBS is the abbreviation of laser-induced breakdown spectroscopy, its working principle is that pulse laser light is focused on a sample to induce the sample to produce atomic emission spectrum of plasma, and then the atomic emission spectrum is extracted by a spectrometer to identify element composition in the sample. Therefore, the LIBS is a technology for material identification, classification, qualitative and quantitative analysis.

With the continuous development of lasers and high-resolution spectrometers, the size and cost have continued to shrink and reduce, LIBS technology has been widely researched and applied, and LIBS detection devices are also gradually miniaturized, and have evolved from large laboratory devices to handheld instruments that can be used outdoors. By retaining the advantages of LIBS technology and focusing on in-situ and on-line analysis, the LIBS instruments are especially suitable for field environment. At present, the reported application fields include environment (water quality detection and soil pollution, etc.), geology (field rock identification) and cultural heritage (ancient buildings and murals), and the commercial applications are mainly metal grade identification and waste metal recycling.

In fact, most of the natural minerals in the field are not absolutely homogeneous, but are doped with some impurity particles, so the operator cannot determine whether the laser target point falls on the sample or on the impurity particles. If the laser target point falls on these impurity particles, the obtained spectral information does not match the sample, and thus the analysis results are affected.

### SUMMARY

For the defect that a LIBS instrument in the prior art cannot determine whether a laser target point falls on a sample or on impurity particles, a hand-held LIBS analysis device with auto-focusing and micro-area imaging functions is provided. The position of the laser target point of the LIBS instrument can be observed when a sample is detected, thus determining whether the laser target point falls on the sample or on the impurity particles and facilitating the use.

The above technical problem is solved through the technical solution adopted by the present disclosure.

A handheld LIBS analysis device with auto-focusing and micro-area imaging functions includes a main body. The device body includes a mounting seat. A pulse laser, an optical path module and an auto-focusing module are arranged on the mounting seat. The optical path module includes a first mounting box, a second mounting box and a third mounting box sequentially arranged from bottom to top. The first mounting box, the second mounting box and the third mounting box are respectively provided with a rotatable perforated total reflector, a beam splitter and a total reflector. The auto-focusing module and the pulse laser are respectively arranged on both sides of the first mounting box and are oppositely arranged in the same horizontal plane. An optical fiber coupler is connected to a side face of the second mounting box. A camera is connected to a side face of the third mounting box. A processing module connected to the optical fiber coupler and the camera are further arranged on the mounting seat.

Through the configuration of the present disclosure, the device body can be used to detect a detected sample. Specifically, laser light is emitted by the pulse laser to induce the surface of the detected sample to generate plasma, and then atomic spectrum emitted by the plasma is reflected to the beam splitter through the perforated total reflector in turn, and a transmission to reflection ratio of the beam splitter is 1:9, such that the atomic spectrum with the intensity ratio of 9/10 is reflected into the optical fiber coupler by the beam splitter, and then enters the processing module, and the atomic spectrum with the intensity ratio of 1/10 is reflected into the camera by the total reflector through the beam splitter, and then the processing module can obtain image information, thereby determining whether a laser target point falls on the detected sample or not. Compared with the prior art, such an operation enables an operator to detect a sample more accurately in the process of using the device, and the use is convenient.

Preferably, one side of each of the first mounting box, the second mounting box and the third mounting box is opened, and the first mounting box, the second mounting box and the third mounting box are integrated by a connecting plate. The first mounting box and the second mounting box are connected with each other through a vertical hole, and the second mounting box and the third mounting box are connected with each other with through a vertical hole. The first mounting box is provided with a penetration hole in a horizontal direction for laser light of the pulse laser to pass through, the side face of the second mounting box is provided with a first through hole in a horizontal direction, and the side face of the third mounting box is provided with a second through hole in a horizontal direction. Each of the first mounting box, the second mounting box and the third mounting box is internally provided with a lens holder. The three lens holders are respectively used for mounting the perforated total reflector, the beam splitter and the total reflector.

Through the arrangement in the present disclosure, the laser light emitted by the pulse laser passes through the penetration hole, and then passes through pinholes to finally fall on the detected sample, thereby obtaining spectral information corresponding to the detected sample. The arrangement of the first through hole and the second through hole in the present disclosure facilitates the atomic spectrum to enter the optical fiber coupler and the camera.

Preferably, an upper side face of the pulse laser is provided with an L-shaped fixing part. The L-shaped fixing part includes a transverse plate mounted on an upper end face of the pulse laser and a vertical plate perpendicular to the transverse plate. An input end of the optical fiber coupler is fixed to the second mounting box and is arranged opposite to the first through hole, and the vertical plate is provided with a mounting port for an output end of the optical fiber coupler to pass through. One side of the camera is perpendicularly mounted on the vertical plate, and a camera lens is provided towards the second through hole.

Through the configuration of the present disclosure, the mounting and fixing of the pulse laser, the optical fiber coupler, the camera and the optical path module on the mounting seat are achieved.

Preferably, each of the first mounting box, the second mounting box and the third mounting box is internally provided with a lens adjustment rotating base, and the lens holder is fixed to the lens adjustment rotating base. A side wall of each of the first mounting box, the second mounting box and the third mounting box is provided with a lens adjustment end cover which is coaxially arranged with the lens adjustment rotating base and can rotate along with the lens adjustment rotating base. The lens adjustment end cover (220) is connected to the lens adjustment rotating base by a bolt, and the bolt is sleeved with a disc spring located between the lens adjustment end cover and the lens adjustment rotating base.

In the present disclosure, through the arrangement of the lens adjustment end cover, the lens adjustment rotating base, the bolt and the disc spring, when the lens needs to be fine-tuned, the bolt is unscrewed, a gap between the lens adjustment end cover and the lens adjustment rotating base is increased by an elastic force of the disc spring, such that the lens adjustment rotating base can rotate along with the lens adjustment end cover to adjust an angle of the lens and further adjust the optical path. When the adjustment is completed, the bolt is screwed tightly to make the lens adjustment end cover abut against an outer wall of the mounting box and to make and the lens adjustment rotating base abut against an inner wall of the mounting box, thereby achieving the fixation of the lens.

Preferably, the processing module includes a spectrometer and a microcomputer, and an optical fiber is connected between the optical fiber coupler and the spectrometer.

In the present disclosure, through the arrangement of the processing module, the atomic spectrum is reflected by the optical fiber coupler into the optical fiber, and then enters the spectrometer, thereby achieving the spectral analysis of the detected sample by the spectrometer. Then, the data information of the detected sample is obtained and is sent to the microcomputer. The microcomputer of the present disclosure is provided with a screen display, which not only can display picture information collected by the camera, but also can display the data information of the detected sample.

Preferably, the auto-focusing module includes a fixing plate fixed to the mounting seat. A fixing seat perpendicular to the fixing plate is arranged on one side of the fixing plate. A motor mounting plate is arranged at one end, away from the fixing seat, of the fixing plate. A driving motor is mounted on the motor mounting plate, a lead screw is connected to a motor shaft of the driving motor, and a sliding seat is threaded to the lead screw. A focusing rail capable of moving towards or away from the fixing seat is arranged on the sliding seat.

In the present disclosure, through the arrangement of the fixing seat, the driving motor, the lead screw, the sliding seat and the focusing rail, the driving motor can drive the lead screw to rotate when the pulse laser carries out laser target shooting on the detected sample, then the sliding seat is enabled to drive the focusing rail to move towards or away from the fixing seat in an axial direction of the lead screw, thereby achieving the auto-focusing of the laser target point on the surface of the detected sample.

Preferably, two slide rails which are arranged in parallel and have the same length direction as an axial direction of the lead screw are arranged on the fixing plate. A slider capable of sliding along the length direction of the slide rail is arranged on each of the two slide rails. A rectangular block for connecting the two sliders is arranged on upper end faces of the two sliders. The focusing rail is fixed to an upper end face of the rectangular block, and the sliding seat is fixed to a lower end face of the rectangular block and is provided between the two slide rails.

In the present disclosure, through the arrangement of the sliders and the slide rails, the two sliders can keep sliding on the slide rails in the process that the lead screw drives the focusing rail to move towards or away from the fixing seat in the axial direction of the lead screw, thus improving the stability of the movement of the focusing rail.

Preferably, each of the fixing seat and the focusing rail is provided with a mounting hole, and the two mounting holes are provided coaxially. A contact end is provided on a side face, away from the focusing rail, of the fixing seat and is located at the mounting hole of the fixing seat. A focusing lens group is provided at the position, away from the fixing seat, of the focusing rail and is located at the mounting hole of the focusing rail. The focusing lens group includes a mounting cylinder with openings at both ends. One end, close to the focusing rail, in the mounting cylinder is provided with a plano-convex lens, and a planar lens of the plano-convex lens is arranged towards the mounting hole of the focusing rail.

Through the arrangement in the present disclosure, when the contact end makes contact with the surface of the detected sample, the laser light emitted by the pulse laser passes through the focusing lens group. Further, the laser beam is fully focused on a focal point of the plano-convex lens under the action of the plano-convex lens, and the focused focal point falls on the detected sample by adjusting the position of the focusing rail on the fixing plate, thereby enabling the laser target point to fall on the detected sample.

Preferably, a square clamping groove is formed in an end face of the sliding seat. The lead screw is sleeved with an anti-backlash shaft sleeve. The anti-backlash shaft sleeve includes a shaft sleeve body, one end of the shaft sleeve body is provided with a convex ring, and the other end of the shaft sleeve body is provided with two opposite bumps. The two bumps together form a clamping part clamped into the clamping groove.

In the present disclosure, the bumps are clamped into in the clamping groove all the time through due to the arrangement of the anti-backlash shaft sleeve. Due to the fact that there is an error of backlash in the movement process of the focusing rail towards or away from the fixing seat, an axial compression spring adjustment method is adopted, such that the anti-backlash shaft sleeve can eliminate the error of backlash, and then the reliability of the auto-focusing module is improved.

Preferably, the device body also includes a grip mounted on a lower end face of the mounting seat. The grip is provided with a trigger switch and a battery box arranged on a lower end face of the grip.

In the present disclosure, through the arrangement of the grip, the trigger switch and the battery box, after the trigger switch is pressed to facilitate an operator to align the contact end with the detected sample, the pulse laser emits laser light under the action of the trigger switch. Through the arrangement of the battery box, the continuous power supply of the device is guaranteed.

Based on any of the above devices, the embodiment also provides application of the device in LIBS analysis.

### BRIEF DESCRIPTION OF THE DRAWINGS

FIG. 1 is a structural schematic diagram of a device body in accordance with an embodiment 1;

FIG. 2 is a structural schematic diagram of a device body in accordance with an embodiment 1 from another perspective:

FIG. 3 is a semi-sectional schematic diagram of a device body in accordance with an embodiment 1:

FIG. 4 is a hand-holding schematic diagram of a device body in accordance with an embodiment 1.

The names of the parts referred to by the numerals in the accompanying drawings are as follows:
110—mounting seat; 120—pulse laser; 130—microcomputer; 140a—first mounting box; 140b—second mounting box; 140c—third mounting box; 141—connecting plate; 150—camera; 160—optical fiber coupler; 161—optical fiber; 170—L-shaped fixing part; 180—fixing seat; 181—mounting sleeve; 182—focusing rail; 183—mounting cylinder; 184—contact end; 190—slide rail; 191—slider; 210—spectrometer; 220—lens adjustment end cover; 310—lens holder; 320a—perforated total reflector; 320b—beam splitter; 320c—total reflector; 330—driving motor; 331—lead screw; 340—plano-convex lens; 510—transverse plate; 520—vertical plate; 530—mounting port; 710—penetration hole; 720—first through hole; 730—second through hole; 1010—lens adjustment rotating base; 1210—fixing plate; 1211—motor mounting plate; 1220—anti-backlash shaft sleeve; 1310—mounting hole; 1410—rectangular block; 1420—sliding seat; 1421—clamping groove; 1430—LED lamp bead; 2010—convex ring; 2020—bump; 2110—grip; 2111—trigger switch; 2120—battery box.

### DETAILED DESCRIPTION OF THE EMBODIMENTS

To further understand the contents of the present disclosure, the present disclosure is described in detail with reference to the accompanying drawings and embodiments. It should be understood that the embodiments are only explanatory and not intended to limit the present disclosure.

### Embodiment 1

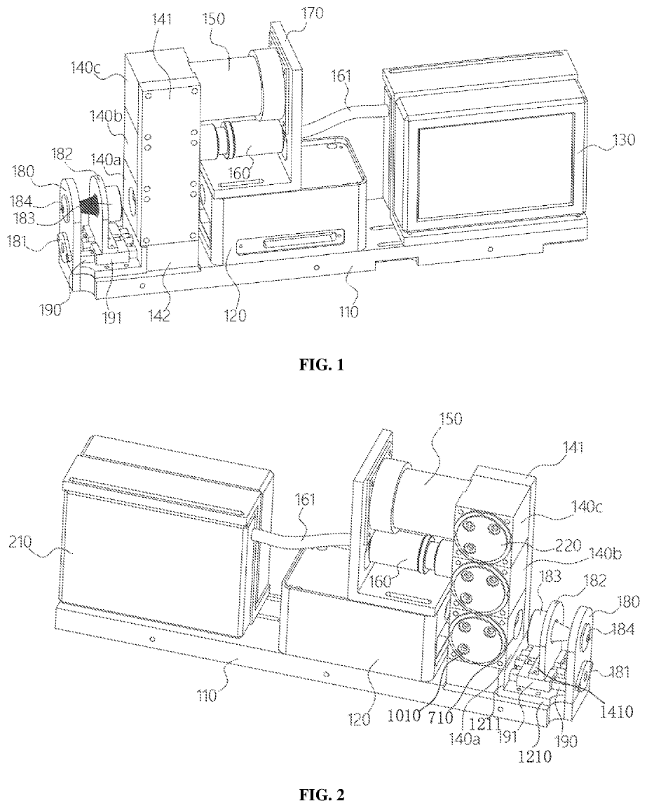

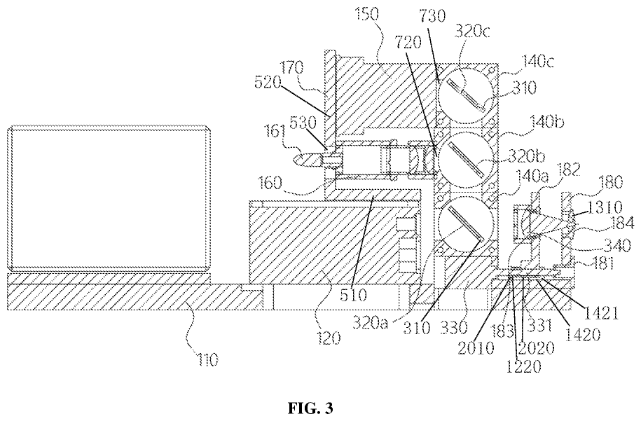

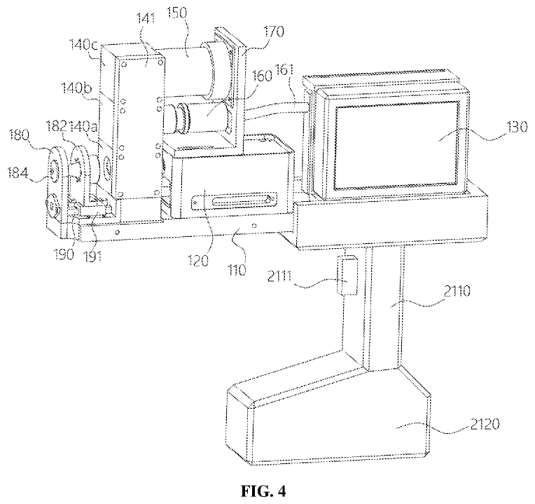

As shown in FIG. 1 through FIG. 4, a handheld LIBS analysis device with auto-focusing and micro-area imaging functions is provided in accordance with this embodiment, including a device body. The device body includes a mounting seat 110. A pulse laser 120, an optical path module and an auto-focusing module are arranged on the mounting seat 110. The optical path module includes a first mounting box 140a, a second mounting box 140b and a third mounting box 140c sequentially arranged from bottom to top. The first mounting box 140a, the second mounting box 140b and the third mounting box 140c are respectively provided with a rotatable perforated total reflector 320a, a beam splitter 320b and a total reflector 320c. The auto-focusing module and the pulse laser 120 are respectively arranged on both sides of the first mounting box 140a and are oppositely arranged in the same horizontal plane. An optical fiber coupler 160 is connected to a side face of the second mounting box 140b. A camera 150 is connected to a side face of the third mounting box 140c. A processing module connected to the optical fiber coupler 160 and the camera 150 are further arranged on the mounting seat 110.

Through the configuration of the present disclosure, the device body can be used to detect a detected sample. Specifically, a laser is emitted by the pulse laser 120 to induce a surface of the detected sample to generate plasma, and then atomic spectrum emitted by the plasma is reflected to the beam splitter 320b through the perforated total reflector 320a in turn, and a transmission to reflection ratio of the beam splitter 320b is 1:9, such that the atomic spectrum with the intensity ratio of 9/10 is reflected into the optical fiber coupler 160 by the beam splitter 320b, and then enters the processing module, and the atomic spectrum with the intensity ratio of 1/10 is reflected into the camera 150 by the total reflector 320c through the beam splitter 320b, and then the processing module can obtain image information, thereby determining whether a laser target point falls on the detected sample or not. Compared with the prior art, such an operation enables an operator to detect a sample more accurately in the process of using the device, and the use is convenient.

In this embodiment, the perforated total reflector 320a, the beam splitter 320b, and the total reflector 320c are all mounted obliquely at 45 degrees, and the perforated total reflector 320a is provided with pinholes in an oblique direction of 45 degrees.

Through the configuration in this embodiment, it is preferable that the atomic spectrum enters the optical fiber coupler 160 and the camera 150 in a predetermined optical path. The function of the pinhole is to facilitate the pulse laser 120 to induce the atomic spectrum of the detected sample, such that all spectral information of the atomic spectrum of the detected sample enters the optical fiber coupler 160 and the camera 150 in the predetermined optical path in equal proportion.

In this embodiment, one side of each of the first mounting box 140a, the second mounting box 140b and the third mounting box 140c is opened, and the first mounting box 140a, the second mounting box 140b and the third mounting box 140c are integrated by a connecting plate 141. The first mounting box 140a and the second mounting box 140b are connected with each other through a vertical hole, and the second mounting box 140b and the third mounting box 140c are connected with each other with through a vertical hole. The first mounting box 140a is provided with a penetration hole 710 in a horizontal direction for laser light of the pulse laser 120 to pass through, the side face of the second mounting box 140b is provided with a first through hole 720 in a horizontal direction, and the side face of the third mounting box 140c is provided with a second through hole 730 in a horizontal direction. Each of the first mounting box 140a, the second mounting box 140b and the third mounting box 140c is internally provided with a lens holder 310. Three lens holders 310 are respectively used for mounting the perforated total reflector 320a, the beam splitter 320b and the total reflector 320c.

Through the configuration in this embodiment, the laser light emitted by the pulse laser 120 passes through the penetration hole 710, then passes through pinholes to finally fall on the detected sample, thereby obtaining the spectral information corresponding to the detected sample. The arrangement of the first through hole 710 and the second through hole 720 in this embodiment facilitates the atomic spectrum to enter the optical fiber coupler 160 and the camera 150. The arrangement of the lens holder 310 in this embodiment achieves the mounting of the lens.

In this embodiment, an upper side face of the pulse laser 120 is provided with an L-shaped fixing part 170. The L-shaped fixing part 170 includes a transverse plate 510 mounted on an upper end face of the pulse laser 120 and a vertical plate 520 perpendicular to the transverse plate 510. An input end of the optical fiber coupler 160 is fixed to the second mounting box 140b and is arranged opposite to the first through hole 720, and the vertical plate 520 is provided with a mounting port 530 for an output end of the optical fiber coupler 160 to pass through. One side of the camera 150 is perpendicularly mounted on the vertical plate 520, and a camera lens is provided towards the second through hole 730.

Through the configuration in this embodiment, the mounting and fixing of the pulse laser 120, the optical fiber coupler 160, the camera 150 and the optical path module on the mounting seat 110 are achieved.

In this embodiment, each of the first mounting box 140a, the second mounting box 140b and the third mounting box 140c is internally provided with a lens adjustment rotating base 1010, and the lens holder 310 is fixed to the lens adjustment rotating base 1010. A side wall of each of the first mounting box 140a, the second mounting box 140b and the third mounting box 140c is provided with a lens adjustment end cover 220 which is coaxially arranged with the lens adjustment rotating base 1010 and can rotate along with the lens adjustment rotating base 1010. The lens adjustment end cover 220 is connected to the lens adjustment rotating base 1010 by a bolt, and the bolt is sleeved with a disc spring located between the lens adjustment end cover 220 and the lens adjustment rotating base 1010.

Through the configuration in this embodiment, when the lens needs to be fine-tuned, the bolt is unscrewed, a gap between the lens adjustment end cover 220 and the lens adjustment rotating base 1010 is increased by an elastic force of the disc spring, such that the lens adjustment rotating base 1010 can rotate along with the lens adjustment end cover 220 to adjust an angle of the lens and further adjust the optical path. When the adjustment is completed, the bolt is screwed tightly to make the lens adjustment end cover 220 abut against an outer wall of the mounting box and to make and the lens adjustment rotating base 1010 abut against an inner wall of the mounting box, thereby achieving the fixation of the lens.

In this embodiment, the processing module includes a spectrometer 210 and a microcomputer 130, and an optical fiber 161 is connected between the optical fiber coupler 160 and the spectrometer 210.

Through the arrangement of the processing module in this embodiment, the atomic spectrum is reflected by the optical fiber coupler 160 into the optical fiber 161, and then enters the spectrometer 210, thereby achieving the spectral analysis of the detected sample by the spectrometer 210. Then, the data information of the detected sample is obtained and is sent to the microcomputer 130. The microcomputer 130 of the present disclosure is provided with a screen display, which not only can display picture information collected by the camera 150, but also can display the data information of the detected sample.

In this embodiment, the auto-focusing module includes a fixing plate (1210) fixed to the mounting seat 110. A fixing seat 180 perpendicular to the fixing plate 1210 is arranged on one side of the fixing plate 1210, a motor mounting plate 1211 is arranged at one end, away from the fixing seat 180, of the fixing plate 1210. A driving motor 330 is mounted on the motor mounting plate 1211, a lead screw 331 is connected to a motor shaft of the driving motor 330, a sliding seat 1420 is threaded to the lead screw 331, and a focusing rail 182 capable of moving towards or away from the fixing seat 180 is arranged on the sliding seat 1420.

Through the configuration in this embodiment, the driving motor 330 can drive the lead screw 331 to rotate when the pulse laser 120 carries out laser target shooting on the detected sample, and the sliding seat 1420 is enabled to drive the focusing rail 182 to move towards or away from the fixing seat 180 in an axial direction of the lead screw 331, thereby achieving the auto-focusing of the laser target point on the surface of the detected sample.

A lower end face of the fixing seat 180 is provided with a mounting sleeve 181 for one end of the lead screw 331 to pass through, thus achieving the stable rotation of the lead screw 331 preferably.

In this embodiment, two slide rails 190 which are arranged in parallel and have the same length direction as an axial direction of the lead screw 331 are arranged on the fixing plate 1210. A slider 191 capable of sliding along the length direction of the slide rail 190 is arranged on each of the two slide rails 190. A rectangular block 1410 for connecting the two sliders 191 is arranged on upper end faces of the two sliders 191. The focusing rail 182 is fixed to an upper end face of the rectangular block 1410, and the sliding seat 1420 is fixed to a lower end face of the rectangular block 1410 and is provided between the two slide rails 190.

Through the configuration in this embodiment, the two sliders 191 can keep sliding on the slide rails 190 in the process that the lead screw 331 drives the focusing rail 182 to move towards or away from the fixing seat 180 in the axial direction of the lead screw, thus improving the stability of the movement of the focusing rail 182.

In this embodiment, each of the fixing seat 180 and the focusing rail 182 is provided with a mounting hole 1310, and the two mounting holes 1310 are provided coaxially. A contact end 184 is provided on a side face, away from the focusing rail 182, of the fixing seat 180 and is located at the mounting hole 1310 of the fixing seat 180. A focusing lens group is provided at the position, away from the fixing seat 180, of the focusing rail 182 and is located at the mounting hole 1310 of the focusing rail 182. The focusing lens group include a mounting cylinder 183 with openings at both ends. One end, close to the focusing rail 182, in the mounting cylinder 183 is provided with a plano-convex lens 340, and a planar lens of the plano-convex lens 340 is arranged towards the mounting hole 1310 of the focusing rail 182.

Through the configuration in this embodiment, when the contact end 184 makes contact with the surface of the detected sample, the laser emitted by the pulse laser 120 passes through the focusing lens group. Further, a laser beam is fully focused on a focal point of the plano-convex lens 340 under the action of the plano-convex lens 340, and the focused focal point falls on the detected sample by adjusting the position of the focusing rail 182 on the fixing plate 1210, thereby enabling the laser target point to fall on the detected sample.

A contact surface of the contact end 184 is a tapered surface, so as to make contact with the detected sample better and increase a certain sample detection area.

In this embodiment, a square clamping groove 1421 is formed in an end face of the sliding seat 1420. The lead screw 331 is sleeved with an anti-backlash shaft sleeve 1220, the anti-backlash shaft sleeve 1220 includes a shaft sleeve body. One end of the shaft sleeve body is provided with a convex ring 2010, and the other end of the shaft sleeve body is provided with two opposite bumps 2020. The two bumps 2020 together form a clamping part clamped into the clamping groove 1421.

Through the arrangement of the anti-backlash shaft sleeve 1220 in this embodiment, the bumps 2020 are clamped in the clamping groove 1421 all the time. Due to the fact that there is an error of backlash in the movement process of the focusing rail 182 towards or away from the fixing seat 180, an axial compression spring adjustment method is adopted, such that the anti-backlash shaft sleeve 1220 can eliminate the error of backlash, and then the reliability of the auto-focusing module is improved.

In this embodiment, the device body also includes a grip 2110 mounted on a lower end face of the mounting seat 110. The grip 2110 is provided trigger switch 2111, and a battery box 2120 arranged on a lower end face of the grip 2110.

Through the configuration in this embodiment, after the trigger switch 2111 is pressed to facilitate an operator to align the contact end 184 with the detected sample, the pulse laser 120 emits laser light under the action of the trigger switch 2111. Through the arrangement of the battery box 2120, the continuous power supply of the device is guaranteed.

In this embodiment, one side face, opposite to the fixing seat 180, of the focusing rail 182 is provided with LED lamp beads 1430 in a circumferential direction of the mounting hole on the focusing rail 182.

Through the configuration in this embodiment, the LED lamp beads 1430 provide illumination when the light is poor, thus facilitating the operator to observe the detected sample better.

During the specific use of the handheld LIBS analysis device with auto-focusing and micro-area imaging functions in this embodiment, the grip 2110 is held to make the contact end 184 align with the detected sample. At this time, the microcomputer 130 is used to control the driving motor 330 to drive the focusing rail 182 to move on the fixing plate 1210, thus making a laser target point fall on the detected sample. The trigger switch 2111 is toggled to enable the pulse laser 120 to emit laser light to induce the plasma generated on the surface of the detected sample, and the plasma atomic spectrum of the detected sample enters the optical fiber coupler 160 and the camera 150 in a predetermined optical path, and the optical fiber coupler 160 is used to reflect the received atomic spectrum into the spectrometer 210 through the optical fiber 161, and thus the spectrometer 210 can detect spectral information of the detected sample. The camera 150 is used to send collected picture information to the microcomputer 130, such that the picture information can be displayed on a screen of the microcomputer 130 for the operator to observe.

To sum up, the above is only the preferred embodiment of the present disclosure, and equal changes and modifications made according to the patent application scope of the present disclosure should be covered by the scope of patent of the present disclosure.

What is claimed is:

1. A handheld LIBS (Laser-Induced Breakdown Spectroscopy) analysis device with auto-focusing and micro-area imaging functions, comprising a device body, wherein the device body comprises a mounting seat (110): a pulse laser (120), an optical path module and an auto-focusing module are arranged on the mounting seat (110): the optical path module comprises a first mounting box (140a), a second mounting box (140b) and a third mounting box (140c) sequentially arranged from bottom to top: the first mounting box (140a), the second mounting box (140b) and the third mounting box (140c) are internally provided with a rotatable perforated total reflector (320a), a beam splitter (320b) and a total reflector (320c), respectively: the auto-focusing module and the pulse laser (120) are respectively arranged on both sides of the first mounting box (140a) and are oppositely arranged in the same horizontal plane: an optical fiber coupler (160) is connected to a side face of the second mounting box (140b): a camera (150) is connected to a side face of the third mounting box (140c); and a processing module connected to the optical fiber coupler (160) and the camera (150) are further arranged on the mounting seat (110).

2. The handheld LIBS analysis device with auto-focusing and micro-area imaging functions according to claim 1, wherein one side of each of the first mounting box (140a), the second mounting box (140b) and the third mounting box (140c) is opened, and the first mounting box (140a), the second mounting box (140b) and the third mounting box (140c) are integrated by a connecting plate (141): the first mounting box (140a) and the second mounting box (140b) are connected with each other through a vertical hole, and the second mounting box (140b) and the third mounting box (140c) are connected with each other with through a vertical hole: the first mounting box (140a) is provided with a penetration hole (710) in a horizontal direction for laser light of the pulse laser (120) to pass through, the side face of the second mounting box (140b) is provided with a first through hole (720) in a horizontal direction, and the side face of the third mounting box (140c) is provided with a second through hole (730) in a horizontal direction: each of the first mounting box (140a), the second mounting box (140b) and the third mounting box (140c) is internally provided with a lens holder (310); and the three lens holders (310) are respectively used for mounting the perforated total reflector (320a), the beam splitter (320b) and the total reflector (320c).

3. The handheld LIBS analysis device with auto-focusing and micro-area imaging functions according to claim 2, wherein an upper side face of the pulse laser (120) is provided with an L-shaped fixing part (170), the L-shaped fixing part (170) comprises a transverse plate (510) mounted on an upper end face of the pulse laser (120) and a vertical plate (520) perpendicular to the transverse plate (510), an input end of the optical fiber coupler (160) is fixed to the second mounting box (140b) and is arranged opposite to the first through hole (720), and the vertical plate (520) is provided with a mounting port (530) for an output end of the optical fiber coupler (160) to pass through; and one side of the camera (150) is perpendicularly mounted on the vertical plate (520), and a camera lens is provided towards the second through hole (730).

4. The handheld LIBS analysis device with auto-focusing and micro-area imaging functions according to claim 2, wherein each of the first mounting box (140a), the second mounting box (140b) and the third mounting box (140c) is internally provided with a lens adjustment rotating base (1010), and the lens holder (310) is fixed to the lens adjustment rotating base (1010); a side wall of each of the first mounting box (140a), the second mounting box (140b) and the third mounting box (140c) is provided with a lens adjustment end cover (220) which is coaxially arranged with the lens adjustment rotating base (1010) and is able to rotate along with the lens adjustment rotating base (1010), the lens adjustment end cover (220) is connected to the lens adjustment rotating base (1010) by a bolt, and the bolt is sleeved with a disc spring located between the lens adjustment end cover (220) and the lens adjustment rotating base (1010).

5. The handheld LIBS analysis device with auto-focusing and micro-area imaging functions according to claim 1, wherein the processing module comprises a spectrometer (210) and a microcomputer (130), and an optical fiber (161) is connected between the optical fiber coupler (160) and the spectrometer (210).

6. The handheld LIBS analysis device with auto-focusing and micro-area imaging functions according to claim 1, wherein the auto-focusing module comprises a fixing plate (1210) fixed to the mounting seat (110), a fixing seat (180) perpendicular to the fixing plate (1210) is arranged on one side of the fixing plate (1210), a motor mounting plate (1211) is arranged at one end, away from the fixing seat (180), of the fixing plate (1210), a driving motor (330) is mounted on the motor mounting plate (1211), a lead screw (331) is connected to a motor shaft of the driving motor (330), a sliding seat (1420) is threaded to the lead screw (331), a focusing rail (182) is arranged on the sliding seat (1420), and moves towards or away from the fixing seat (180).

7. The handheld LIBS analysis device with auto-focusing and micro-area imaging functions according to claim 1, wherein two slide rails (190) which are arranged in parallel and have the same length direction as an axial direction of the lead screw (331) are arranged on the fixing plate (1210), a slider (191) is arranged on each of the two slide rails (190), and slides in a length direction of the slide rail (190): a rectangular block (1410) for connecting the two sliders (191) is arranged on upper end faces of the two sliders (191), the focusing rail (182) is fixed to an upper end face of the rectangular block (1410), and the sliding seat (1420) is fixed to a lower end face of the rectangular block (1410) and is provided between the two slide rails (190).

8. The handheld LIBS analysis device with auto-focusing and micro-area imaging functions according to claim 6, wherein each of the fixing seat (180) and the focusing rail (182) is provided with a mounting hole (1310), and the two mounting holes (1310) are provided coaxially: a contact end (184) is provided on a side face, away from the focusing rail (182), of the fixing seat (180) and is located at the mounting hole (1310) of the fixing seat (180): a focusing lens group is provided at the position, away from the fixing seat (180), of the focusing rail (182) and is located at the mounting hole (1310) of the focusing rail (182): the focusing lens group comprises a mounting cylinder (183) with openings at both ends, one end, close to the focusing rail (182), in the mounting cylinder (183) is provided with a plano-convex lens (340), and a planar lens of the plano-convex lens (340) is arranged towards the mounting hole (1310) of the focusing rail (182).

9. The handheld LIBS analysis device with auto-focusing and micro-area imaging functions according to claim 7, wherein each of the fixing seat (180) and the focusing rail (182) is provided with a mounting hole (1310), and the two mounting holes (1310) are provided coaxially: a contact end (184) is provided on a side face, away from the focusing rail (182), of the fixing seat (180) and is located at the mounting hole (1310) of the fixing seat (180); a focusing lens group is provided at the position, away from the fixing seat (180), of the focusing rail (182) and is located at the mounting hole (1310) of the focusing rail (182); the focusing lens group comprises a mounting cylinder (183) with openings at both ends, one end, close to the focusing rail (182), in the mounting cylinder (183) is provided with a plano-convex lens (340), and a planar lens of the plano-convex lens (340) is arranged towards the mounting hole (1310) of the focusing rail (182).

10. The handheld LIBS analysis device with auto-focusing and micro-area imaging functions according to claim 7, wherein a square clamping groove (1421) is formed in an end face of the sliding seat (1420), the lead screw (331) is sleeved with an anti-backlash shaft sleeve (1220), the anti-backlash shaft sleeve (1220) comprises a shaft sleeve body, one end of the shaft sleeve body is provided with a convex ring (2010), and the other end of the shaft sleeve body is provided with two opposite bumps (2020), and the two bumps (2020) together form a clamping part clamped into the clamping groove (1421).
